(19) United States
(12) Patent Application Publication
(10) Pub. No.: US 2010/0263370 A1
(43) Pub. Date: Oct. 21, 2010

(54) MULTI-STAGE TURBOCHARGER REGULATION APPARATUS

(75) Inventors: Chun-I WU, Yunlin County (TW); Jung-Chun Chen, Taipei County (TW); Pai-Hsiu Lu, Taoyuan County (TW); Yu-Feng Lin, Taipei City (TW)

Correspondence Address: Muncy, Geissler, Olds & Lowe, PLLC, 4000 Legato Road, Suite 310, FAIRFAX, VA, 22033, US

(73) Assignee: CHINA ENGINE CORPORATION

(21) Appl. No.: 12/425,887

(22) Filed: Apr. 17, 2009

(51) Int. Cl. F02D 23/00

(52) U.S. Cl. 60/602

(57) ABSTRACT

A multi-stage turbocharger regulation apparatus includes a casing which has a housing chamber, a driving membrane and at least one floating membrane. The housing chamber has at least one blocking portion. The linkage bar runs through the bottom surface of the casing into the housing chamber to couple with a spring. The driving membrane pushes the linkage bar and also pushes the spring between the driving membrane and the bottom surface of the casing. The floating membrane has at least one opening. The driving membrane is pushed by the elastic force of the spring to block the opening. The floating membrane is compressed by a control gas to drive the driving membrane to push the spring and the linkage bar, or force the driving membrane to separate from the floating membrane to push the linkage bar and the spring. Thereby the wastegate can be opened or closed.

### FIELD OF THE INVENTION

The present invention relates to a multi-stage turbocharger regulation apparatus and particularly to an apparatus to control the opening and closing of a wastegate of a turbocharger to adjust pressure boosting value.

### BACKGROUND OF THE INVENTION

In operation control of a turbocharger, the most important issues are rotation speed and loading (opening degree of the throttle). When the rotation speed and loading of the engine are low and exhaust gas is less, all the exhaust gas is channeled to the exhaust gas driven turbine to drive the turbocharger. When the rotation speed and loading have reached a selected level and the exhaust gas reaches a great amount, the turbine operates in an optimum efficiency range to drive the compressor to release high pressure. Once a targeted pressure is reached, a wastegate is opened to regulate the amount of turbine exhaust gas to prevent continuous increasing of the rotation speed and loading and resulting in supersonic speed occurred to the tips of turbine blades that could generate supersonic vibration and damage the turbine blades and casing. Excessive pressure boosting also incurs a greater burden to the engine. Opening of the wastegate channels the pressure of the compressor outlet to an actuator. The air pressure drives a spring to move the actuator. When the boosting pressure has reached a selected level, the pressure exerting to a membrane in the actuator is greater than the elastic force of the spring, then a linkage bar is moved to open the wastegate. The greater the boosting pressure, the greater the pressure exerting to the actuator and the exhaust gas amount discharged through the wastegate also is greater. As a result, the rotation speed of the turbine can be controlled.

Please refer to FIG. 1 for the structure of a conventional actuator 8. It includes a spring pressing membrane 81 connecting to a regulation linkage bar 83, a compressed spring 82 and a boosted pressure orifice 85. The regulation linkage bar 83 runs through the actuator 8 to connect to a screw bar 84 which adjusts a pre-set pressing amount of the compressed spring 82. The screw bar 84 has other end opposite to the regulation linkage bar 83 to connect to a crank 86. Through the crank 86, a valve 72 is driven to open a turbine wastegate 71 located in a driving turbine 7. When the boosting pressure value is too large, the air pressure at the boosted pressure orifice 85 pushes the spring pressing membrane 81 to move the regulation linkage bar 83 to drive the crank 86 and open the turbine wastegate 71, so that a portion of exhaust gas in the driving turbine 7 is discharged to control the rotation speed of the turbine. However, the opened timing and angle of the turbine wastegate 71 is determined by the elasticity coefficient and the pre-set pressing amount of the compressed spring 82. Both of them are pre-set when the turbine is shipped from the plant and cannot be adjusted. With a given spring elasticity coefficient, the greater the pre-set pressure of the compressed spring 82, the greater the air pressure is required to compress the spring pressing membrane 81. Although pressure boosting improves performance, it also creates other problems such as the engine temperature is higher and combustion shock sensitivity increases. A greater amount of fuel has to be injected to cool the engine. Hence fuel consumption is greater. On the other hand, a lower pre-set pressing amount improves fuel consumption, but the performance is poorer. Hence the conventional technique, by relying on constant adjustment of the pre-set pressing amount of the compressed spring 82 or selecting the compressed spring 82 of different elasticity coefficients to control the opening degree of the turbine wastegate 71 to control the rotation speed of the turbocharger encounters a balance problem of performance and fuel consumption.

### SUMMARY OF THE INVENTION

The primary object of the present invention is to solve the problem of the conventional turbocharger engine that cannot provide proper balance of performance and fuel consumption through control of turbine rotation speed.

To achieve the foregoing object, the present invention provides a multi-stage turbocharger regulation apparatus. It is located at one end of a linkage bar to move the linkage bar and control the opening and closing of a wastegate of a turbocharger. The regulation apparatus includes a casing with a housing chamber inside, a driving membrane which has a contact side and a driving side opposite to the contact side, and at least one floating membrane which has a compressed side and a butting side opposite to the compressed side and a stopper. The housing chamber has at least one blocking portion to stop the stopper. The linkage bar runs through the bottom surface of the casing into the housing chamber to couple with a spring. The driving side pushes the linkage bar. The spring is held between the driving membrane and the bottom surface of the casing. The floating membrane has at least one opening leading from the compressed side to the butting side. The butting side is movably in contact with the contact side of the driving membrane. The driving membrane is pushed by the elastic force of the spring so that the contact side blocks the opening. The compressed side of the floating membrane receives pressure of a controlled gas to move the driving membrane and push the spring and linkage bar. The stopper is stopped by the blocking portion. The butting side and the stopper form a displacement space of the driving membrane movable by the control gas to drive the opening of the wastegate.

Compared with the conventional technique, the invention does not need a pre-set pressure to control the spring. Through the pressure receiving area of different membranes, the receiving force on the membranes can be controlled, thereby to control the turbocharger to operate in a whole rotation speed (or loading) range. Thus during low rotation speed (or loading), a desired torque output can be attained and fuel consumption can be controlled. During high rotation speed, a greater horsepower can be increased to get desired performance. As a result, a desired balance of the performance and fuel efficiency of the turbine engine can be accomplished.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional actuator.

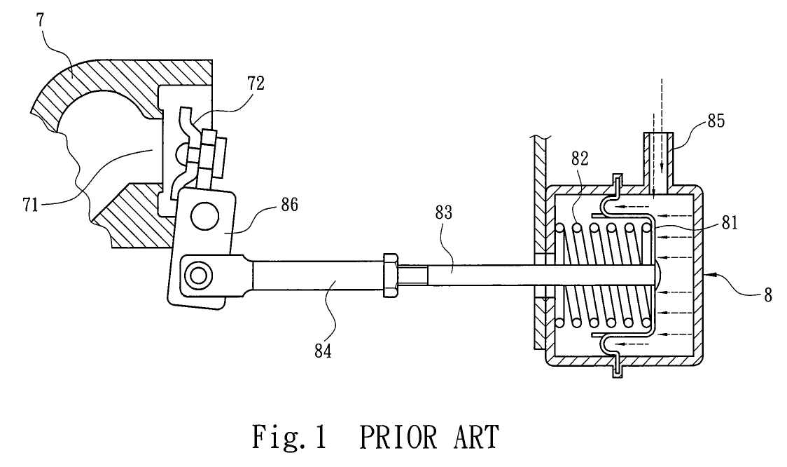

FIG. 2A is a sectional view of the invention.

FIG. 2B is a schematic view of the invention showing pressure release regulation in a medium and low rotation speed operating condition.

FIG. 2C is a schematic view of the invention showing pressure release regulation in a high rotation speed operating condition.

FIG. 3 is a pressure boosting performance comparison chart between the invention and a conventional technique.

### DETAILED DESCRIPTION OF THE PREFERRED EMBODIMENT

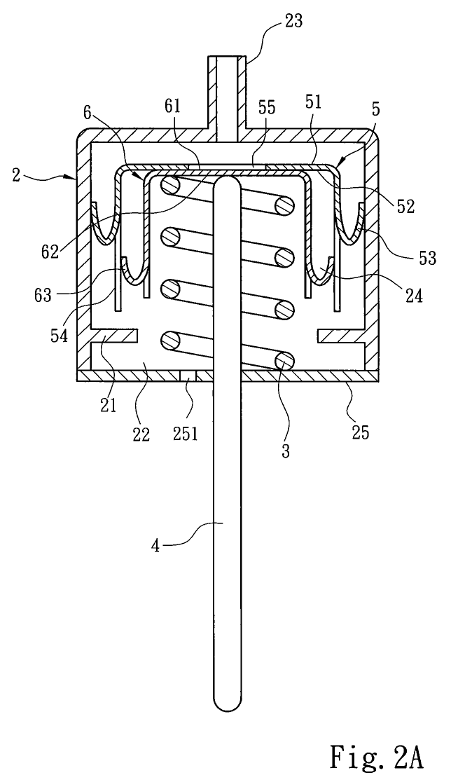

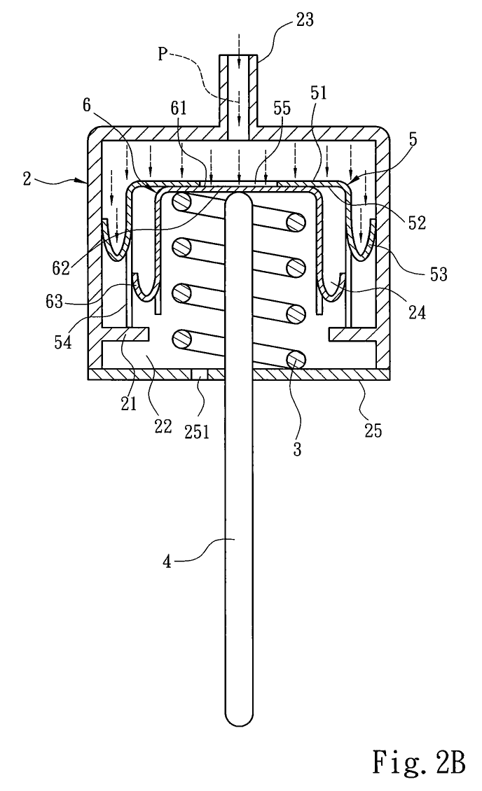

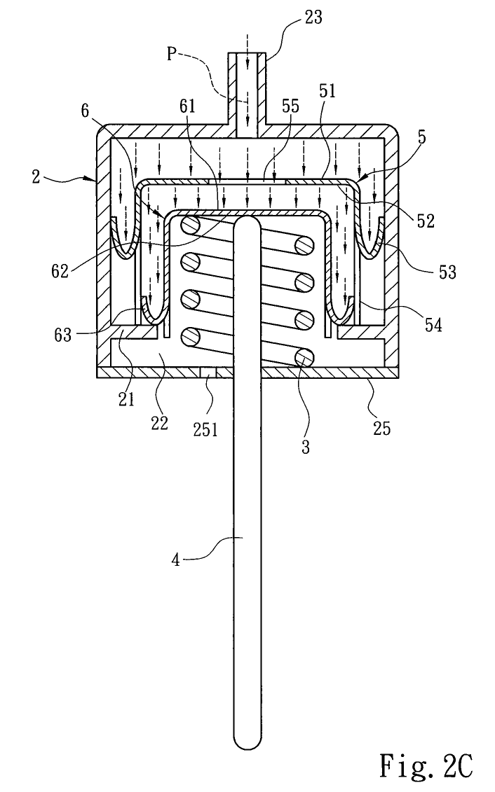

Please refer to FIG. 2A, the present invention provides a multi-stage turbocharger regulation apparatus. It is located at one end of a linkage bar 4 to push the linkage bar 4 to control the opening or closing of a wastegate (not shown in the drawing) of a turbocharger. The regulation apparatus according to the invention includes a casing 2 which has a housing chamber 22 inside. The casing 2 is a cylindrical barrel or a barrel of other geometric shapes. The housing chamber 22 has at least one blocking portion 21. The linkage bar 4 runs through the bottom surface 25 of the casing 2 into the housing chamber 22. The bottom surface 25 has an air hole 251 to discharge extra gas in the casing 2. The casing 2 further has a pressure orifice 23 to receive control gas P (referring to FIG. 2B). Through a pressure sensor (not shown in the drawings), the pressure boosting value of a compressor can be detected to control the control gas P to enter or leave the pressure orifice 23. The pressure orifice 23 is located on a top surface opposite to the bottom surface 25 or on a side wall close to the top surface. The housing chamber 22 holds a spring 3 coupling on the linkage bar 4. There is a driving membrane 6 resting on the spring 3. The driving membrane 6 has a contact side 61 and a driving side 62 opposite to the contact side 61. The driving membrane 6 pushes the linkage bar 4 and the spring 3 through the driving side 62 to move the spring 3 between the driving membrane 6 and the bottom surface 25 of the casing 2. There is a floating membrane 5 located above the driving membrane 6. The floating membrane 5 has a compressed side 51 and a butting side 52 opposite to the compressed side 51, and a stopper 54 stopped by the blocking portion 21. The floating membrane 5 has at least one opening 55 running from the compressed side 51 to the butting side 52. The butting side 52 is movably (separable) in contact with the contact side 61 of the driving membrane 6. The floating membrane 5 and the driving membrane 6 have respectively a first gas isolation portion 53 and a second gas isolation portion 63. The first gas isolation portion 53 is in close contact with the casing 2. The second gas isolation portion 63 is in close contact with the stopper 54 of the floating membrane 5. The spring 3 has one end pressing the bottom surface 25 of the casing 2 and the other end pushing the driving membrane 6 so that the contact side 61 of the driving membrane 6 blocks the opening 55 of the floating membrane 5. The contact side 61 covers the opening 55 so that the compressed side 51 of the floating membrane 5 and the contact side 61 of the driving membrane 6 combine to form a force receiving area. A closed space 24 is formed between the second gas isolation portion 63 and the stopper 54.

Please refer to FIGS. 2B and 2C for the invention in pressure release conditions when used in a medium and low rotation speed (or loading) environment and a high rotation speed (or loading) environment. When the engine is in the medium and low rotation speed (or loading), and the force of the pressure boosting value of the compressor has reached a selected level, the control gas P from the pressure orifice 23 provides a force greater than the force of the spring 3, the combined force receiving area of the compressed side 51 and the contact side 61 receives the pressure of the control gas P, the driving membrane 6 is driven to push the spring 3 and the linkage bar 4, consequently the wastegate (not shown in the drawings) at the other end of the linkage bar 4 is pushed and opened to discharge extra waste gas and regulate the rotation speed of the turbocharger until the stopper 54 is stopped by the blocking portion 21. Referring to FIG. 2C, during high speed (or loading) operation, as the stopper 54 is stopped by the blocking portion 21 without moving, if continuously pushing the linkage bar 4 and the spring 30 to open the wastegate (not shown in the drawings) is required, the driving membrane 6 has to be pushed; as the moving space of the driving membrane 6 pushed by the control gas P is formed by borders of the butting side 61 and the stopper 54, when the driving membrane 6 is pushed by the control gas P, it is moved towards the spring 3. As the force receiving area of the driving membrane 6 is smaller than the combined area of the compressed side 51 and the contact side 61, the force receiving area for pushing the linkage bar 4 and the spring 3 is smaller, the force required to push the control gas P (i.e. the pressure boosting value) has to be greater to open the wastegate (not shown in the drawings) at a greater degree to reach a greater boosting pressure, then high rotation speed (or loading) performance output can be achieved.

Moreover, multiple floating membranes 5 may be provided in the casing 2. Each floating membrane 5 has the butting side 52 blocking the opening 55 of a preceding floating membrane 5. The area of the compressed side 51 fills the opening 55 of the preceding floating membrane 5. Hence the preceding floating membrane 5 has an area pushed by the control gas P. Each floating membrane 5 has the first gas isolation portion 53 to isolate the control gas P. The first gas isolation portion 53 also forms a closed space 24 with the stopper 54 of the preceding floating membrane 5. The driving membrane 6 contacts the butting side 52 of the last floating membrane 6. Namely, there is no limitation of the number of the floating membrane 5 in the regulation apparatus. The main consideration is that the stopper 54 of each floating membrane 5 is stopped by a corresponding blocking portion 21 from moving. To further push the linkage bar 4 and the spring 3, a greater pressure boosting value is needed. Such a structure can achieve multi-stage pressure boosting effect according to variations of the force receiving area.

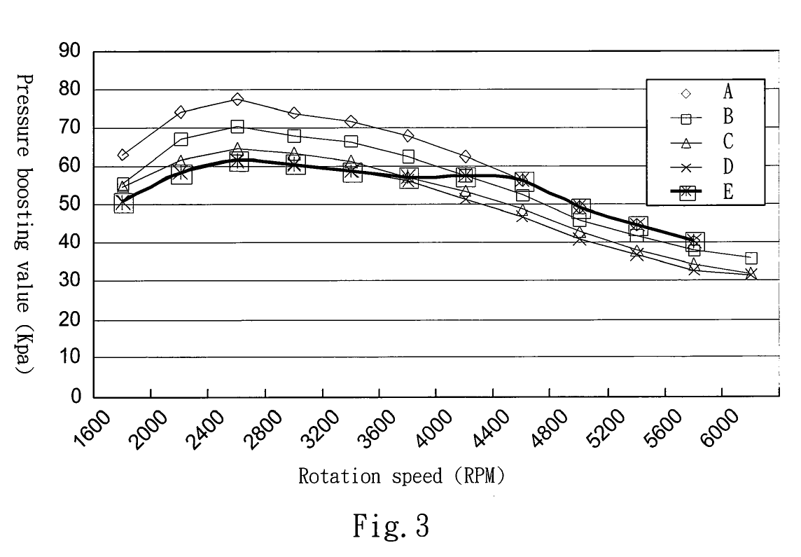

Refer to FIG. 3 for the pressure boosting performance comparison between the invention and a conventional technique. It is obtained by adjusting pre-set pressing amount of the compressed spring 82 of the conventional actuator 8 to do tests related to corresponding variations of the rotation speed and pressure boosting value, with a spring of the same specification deployed on the multi-stage turbocharger regulation apparatus. Curve A shows a greater original pre-set pressing amount of the compressed spring 82. As shown by the curve A, from the lower rotation speed (or loading) to the high rotation speed (or loading), the pressure boosting value is relatively high, and the performance also is greater. Curves B, C and D show that the pre-set pressure of the compressed spring 82 is reduced gradually, the pre-set pressing amount of the curves B, C and D become smaller. The pressure boosting value also decreases from the lower rotation speed (or loading) to the higher rotation speed (or loading) according to the pre-set pressing amount. As a result, each curve levels off lower. The performance also decreases. But fuel efficiency is higher. Curve E shows the test result of the multi-stage turbocharger regulation apparatus. In the medium and low rotation speed range (about 1800-4400 RPM), i.e. the driving speed of regular driving, the multi-stage turbocharger regulation apparatus maintains the performance of the ordinary turbocharger engine. Its performance and pre-set pressing amount overlap with the minimum portion of the curve D, hence can get improved fuel efficiency to save fuel consumption at the medium and low rotation speed (or loading). In the high rotation speed range (about 4400 RPM or over), the multi-stage turbocharger regulation apparatus can achieve a high performance. Its performance and pre-set pressing amount overlap with the maximum portion of the curve A. Thus it proves that the multi-stage turbocharger regulation apparatus can achieve a desired balance to get lower fuel consumption at the medium and lower rotation speed (or loading) and higher performance at the higher rotation speed (or loading).

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A multi-stage turbocharger regulation apparatus located at one end of a linkage bar to push the linkage bar to control opening or closing of a wastegate of a turbocharger, comprising:
a casing which has a housing chamber and a bottom surface run through by the linkage bar in the housing chamber to couple with a spring, the housing chamber having at least one blocking portion;
a driving membrane having a contact side and a driving side opposite to the contact side, the driving side pushing the linkage bar and the spring which is located between the driving membrane and the bottom surface of the casing; and
at least one floating membrane which has a compressed side, a butting side opposite to the compressed side and a stopper stopped by the blocking portion, and at least one opening running from the compressed side to the butting side;
wherein the butting side is movably in contact with the contact side of the driving membrane, the driving membrane receiving an elastic force of the spring to push the contact side to block the opening, the compressed side of the floating membrane receiving a pressure of a control gas to move the driving membrane to push the spring and the linkage bar until the stopper is stopped by the blocking portion so that the butting side and the stopper form a displacement space between them to allow the control gas to push the driving membrane to drive the wastegate to open.

2. The multi-stage turbocharger regulation apparatus of claim 1, wherein the casing holds multiple floating membranes, each floating membrane blocking the opening of a preceding floating membrane, the driving membrane being in contact with the butting side of the last floating membrane.

3. The multi-stage turbocharger regulation apparatus of claim 2, wherein the casing has multiple blocking portions, each floating membrane having a stopper corresponding to one blocking portion to be stopped therewith.

4. The multi-stage turbocharger regulation apparatus of claim 3, wherein the floating membrane has a first gas isolation portion to isolate the control gas, the first gas isolation portion and the stopper of the preceding floating membrane forming a first close space.

5. The multi-stage turbocharger regulation apparatus of claim 1, wherein the floating membrane has a first gas isolation portion to isolate the control gas, the first gas isolation portion and the stopper of a preceding floating membrane forming a close space.

6. The multi-stage turbocharger regulation apparatus of claim 1, wherein the driving membrane has a second gas isolation portion to form a second close space with the stopper of the floating membrane.

7. The multi-stage turbocharger regulation apparatus of claim 1, wherein the casing has a pressure orifice on the top surface thereof opposite to the bottom surface to receive the control gas.

8. The multi-stage turbocharger regulation apparatus of claim 1, wherein the casing has a pressure orifice close to the top surface thereof opposite to the bottom surface to receive the control gas.
